(19) United States
(12) Patent Application Publication
(10) Pub. No.: US 2023/0159193 A1
(43) Pub. Date: May 25, 2023

(54) PLATFORM FOR FACILITATING THE LANDING ON ANY DESIRED COORDINATES, DOCKING, AND RETAKE-OFF OF DEFINED MULTI-PROPELLER AIRCRAFTS / UNMANNED AERIAL VEHICLES

(71) Applicant: ISTANBUL UNIVERSITESI REKTORLUGU, Istanbul (TR)

(72) Inventors: Leyla Turker SENER, Istanbul (TR); Tevfik SOYAK, Ankara (TR)

(73) Assignee: ISTANBUL UNIVERSITESI REKTORLUGU, Istanbul (TR)

(21) Appl. No.: 17/912,083

(22) PCT Filed: Mar. 16, 2021
(86) PCT No.: PCT/TR2021/050237

§ 371 Date: Sep. 16, 2022

(30) Foreign Application Priority Data
Mar. 16, 2020 (TR) 2020/04039

(51) Int. Cl. B64U 70/92

(52) U.S. Cl. CPC B64U 70/92; B64U 2101/64

(57) ABSTRACT

A system used to facilitate the landing of unmanned aerial vehicles on any desired coordinates, and docking and retake-off of them includes a motor operating the platform, a LED lighting employed for an operation of the system under low light conditions, electromagnetic magnets used for fixing the unmanned aerial vehicle on the platform, a transformer box used to supply electrical energy needed by the electromagnetic magnets and the LED lighting, a control cards box hosting control cards employed to control operations of junction boxes, the motor and the electromagnetic magnets, and a cable box through which connection cables of the system pass.

### CROSS REFERENCE TO THE RELATED APPLICATIONS

This application is the national phase entry of International Application No. PCT/TR2021/050237, filed on Mar. 16, 2021, which is based on and claims priority on Turkish patent application No. 2020/04039, filed on Mar. 16, 2020, the entire contents of which are incorporated herein by reference.

### TECHNICAL FIELD

This invention is related to a system used to facilitate the landing of unmanned aerial vehicles on any desired coordinates, and docking and retake-off of them.

### BACKGROUND

Unmanned aerial vehicle (UAV) is a type of remote controlled and/or automatically operating aircraft without a human pilot or passenger on board, carrying only equipment fit for its specific purpose. Currently, unmanned aerial vehicles are designed in various different dimensions and shapes fit for achievement of the specific duties assigned to them. UAVs are categorized in two main groups in terms of specific duties assigned to them, namely military (reconnaissance, armed, attack, etc.) and civil (hobby, scientific and commercial). Use of UAVs for civil purposes has already entered into our daily lives, and developments in this field are increasing each passing day. Unmanned aerial vehicles of small and portable sizes designed for civil purposes are generally used in environmental imaging, mapping, transportation of materials, etc. assignments.

High costs of innercity product distribution, and direct effects thereof on urban traffic are well-known problems of cargo processes. In addition, it takes a very long time to transport cargo to its destination in heavy traffic hours or areas. In strategic plants where quick product transfer is especially important, and if and when it is required to transport products concurrently from one station of the plant to the other or in cases of emergency, to one or more departments, then and in this case, delivery is mostly delayed, or workload is increased due to assignment of several personnel at the same time. Unmanned aerial vehicles are rapidly developed for such assignments in cargo and distribution activities in order to eliminate the aforesaid problems.

Some problems faced by small unmanned aerial vehicles used for these types of assignments at the time of landing on a platform or at the time of taking off therefrom are known. If the targeted landing ground of unmanned aerial vehicles of small size is inclined and uneven, the vehicle may not be able to successfully land thereon and may suffer damages. When such factors as the contents of transported products and the purpose of transportation (especially those related to human health) are taken into consideration, the products damaged together with the unmanned aerial vehicle carrying them may lead to heavy material and moral damages. In order to prevent problems as mentioned above, in the state of the art, some improvements have been tried to be made in respect of landing and take-off processes of unmanned aerial vehicles.

In connection therewith, the US patent document with application number U.S. Pat. No. 9,056,676B1 mentions about a method enabling small size unmanned aerial vehicles to land on and take off from a land vehicle. With regard to this method, it is said that unmanned aerial vehicle follows up a sign on the land vehicle to be landed, and signals for following up this sign are sent to engines fit to unmanned aerial vehicle, and horizontal speed of unmanned aerial vehicle is adjusted to a level allowing it to follow up the sign on the land vehicle, and vertical speed of unmanned aerial vehicle is regularly reduced to a level convenient for its landing on the land vehicle. However, a method or a system applied on the ground to be landed by unmanned aerial vehicles and used for a successful landing is not ever mentioned therein.

### SUMMARY

This invention is related to a system used to facilitate the landing of unmanned aerial vehicles on any desired coordinates, and docking and retake-off of them.

Particularly for cargo distribution process by means of unmanned aerial vehicles, this invention provides an autonomously or manually operated system with an aesthetic design which allows unmanned aerial vehicles to land in front of windows of apartment buildings or structures, and is started up or shut down by a short message approval transmitted from main control centre or via telecommunication network, and when inactive, can be coated by marble, plastic, carbon fibre or similar other materials so as not to deface the external appearance of buildings, and when opened up, turns into a platform for landing of unmanned aerial vehicles.

Upon receipt of a command via mobile phone mobile application or from main control centre of unmanned aerial vehicle sent from the control centre, the platform standing in an inactive position is activated and turns into an active position of 90 degrees permitting the landing of unmanned aerial vehicles. While unmanned aerial vehicle lands on the platform safely, electromagnetic magnets are activated to dock and interlock the unmanned aerial vehicle. Then, the unmanned aerial vehicle remains interlocked with the platform during product delivery process, and completes the delivery safely. After completion of delivery process, both the platform and the electromagnetic magnets are deactivated to release the unmanned aerial vehicle, and then turn back into vertical and inactive position.

Platform is opened up by movement of steel pipe, constituting its main body, with the help of a motor of AC 12V. Solar panels may also be used as the source of energy needed thereinfor. Platform is also equipped by a led lighting made of ultraviolet resistant material, coated by water- and dirt-repellant nanocomposite coating insulated with waterproof features, and containing a cooling unit. Platform is operable at a temperature range of −20 to +60 degrees centigrade. Furthermore, platform includes Arduino circuit board and control cards used for balancing the communication between AC motor and electromagnetic magnets.

The cargo is ensured to be delivered at the correct point of destination without a deviation in landing point by means of artificial intelligent-neural networks and visual mapping—image processing. While the platform is closed, unmanned aerial vehicle visually reads the QR code marked on the platform and confirms that it is at the correct point of destination.

RFID (Radio Frequency Identification), infrared and mechanical system containing a physical programming platform operated by artificial intelligence ensures that platform automatically opens up when unmanned aerial vehicle approaches only after security protocols are approved, and that in the case of a sales dispatch, product price is paid by an approval message received by mobile phone of purchaser, and that when unmanned aerial vehicle is landed, it is safely docked and fixed by magnetic or mechanical interlocking without being affected from weather conditions.

Having been placed in front of window, the platform ensures that unmanned aerial vehicle is safely landed and docked to port, and thereafter, when needed, it is released and easily takes off. As it contains a physical programming platform, it may also be controlled via internet.

In case of purchases via internet, and in case of delivery by unmanned aerial vehicles, the platform identifies from where the dispatch is sent, and is activated to allow landing of the unmanned aerial vehicle, and upon arrival, cargo is taken into house upon a mobile phone approval through an additional automatic opening and closing window, being the subject of a separate patent application, and then, the window is automatically closed and interlocked.

### BRIEF DESCRIPTION OF THE DRAWINGS

The invention will be described with reference to the figures attached hereto, thus making sure that the specifications of invention are better understood and acknowledged, but its purpose is by no means to limit the invention with these drawings. On the contrary, it is intended to cover all alternatives, modifications and equivalences that may be included in the field of the invention described by the claims attached hereto. It should also be understood and noted that the details given herein are shown only to describe the preferred arrangements of the present invention, and that they are presented in order to give the most practical and easily understandable definition of both shaping of the methods and rules and conceptual features of the invention. These drawings are as listed below:

FIG. 1 shows a general appearance of the platform in inactive and active positions.

FIG. 2 shows an assembled appearance of components of the system.

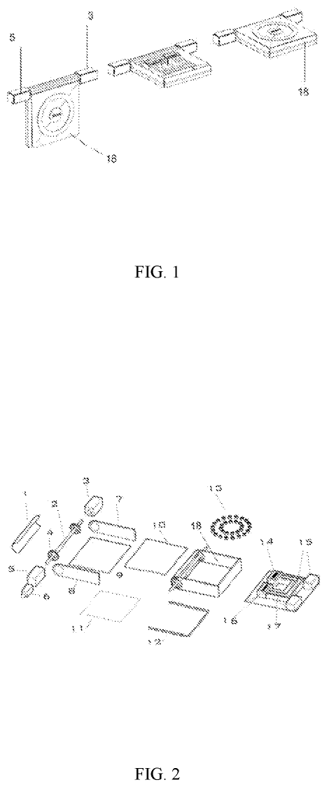

FIGS. 1-2 aim to help the comprehension of this invention are numbered as specified in the drawing attached hereto, and are named and listed below.

### REFERENCE NUMBERS IN DRAWINGS

1. Rear cover
2. Main carrier bar
3. Retaining disk
4. Roller bearing carrier
5. Motor roller bearing carrier
6. Motor
7. Body left side part
8. Body right side part
9. Body bottom part
10. Body top part
11. Rubber insulation band
12. LED lighting
13. Electromagnetic magnets
14. Transformer box
15. Junction boxes
16. Control cards box
17. Cable box
18. Main body

### DETAILED DESCRIPTION OF THE EMBODIMENTS

This invention is related to a system used to facilitate the landing of unmanned aerial vehicles on any desired coordinates, and docking and retake-off of them.

This invention is characterized by a combination of rear cover (1), main carrier bar (2), retaining disk (3), roller bearing carrier (4), motor roller bearing carrier (5), motor (6), body left side part (7), body right side part (8), body bottom part (9) and body top part (10) as shown in FIG. 2, thereby building a platform assuring safe landing of unmanned aerial vehicles even under inappropriate weather and ground conditions, as detailed in FIG. 1.

Control cards box (16), thanks to Arduino, motor and electromagnetic magnet control cards contained therein, transmits to motor (6) the signals received from main control centre or via mobile phone mobile application, and first of all, activates (opens) the platform for landing of unmanned aerial vehicle. On the platform activated at the time of landing, in line with the signals received from control cards, electromagnetic magnets (13) under body top part (10) are activated, to make sure that unmanned aerial vehicle lands safely and stably. Then, unmanned aerial vehicle is interlocked with platform via electromagnetic magnets (13) under body top part (10), and remains fixed and still during manual receipt of the cargo carried.

This invention includes a platform used for safe landing and take-off of unmanned aerial vehicles. Parts constituting the main body (18) of said platform are rear cover (1), main carrier bar (2), roller bearing carrier (4), body left side part (7), body right side part (8), body bottom part (9) and body top part (10).

Furthermore, the invented system also includes a retaining disk (3) and AC motor and roller bearing carrier (5) employed for fixing and retaining the platform at any place desired.

Said platform contains a cooling unit, is insulated with waterproof features, is coated by water- and dirt-repellant nanocomposite coating, and is operable at a temperature range of −20 to +60 degrees centigrade thanks to its structure made of ultraviolet (UV) resistant material, and the insulation band (11) included therein.

In this invention, the platform is ensured to turn into the desired position thanks to motor (6) included in motor roller bearing carrier (5). Motor (6) activates the platform to turn into active (open) or inactive (closed) positions in line with signals received from main control centre or via mobile phone mobile application.

Furthermore, as the invented system contains a physical programming platform, it may also be controlled via internet.

In addition, the invented system ensures delivery of cargo at the correct point of destination without any deviation in landing point via its neural networks and visual mapping—image processing.

While the platform is inactive (closed), unmanned aerial vehicle visually reads the QR code marked on the platform and confirms that it is at the correct point of destination. Platform contains a LED lighting (12) for effective operation of visual activities under low light conditions.

After unmanned aerial vehicle is landed, when it is required to take off, electromagnetic magnets (13) under body top part (10) are deactivated in line with signals received from control cards to release the unmanned aerial vehicle, thus making the unmanned aerial vehicle ready to take off.

Furthermore, the invented system contains a 12V transformer in transformer box (14) in order to supply electrical energy needed by electromagnetic magnets (13) and LED lighting (12).

What is claimed is:

1. A system used to facilitate a landing, docking and retake-off of an unmanned aerial vehicle on any desired coordinates, wherein the system is used by the following steps:
after receiving a command via a mobile phone mobile application or from a main control centre, activating a platform standing in an inactive position to turn into an active position of 90 degrees permitting the landing of the unmanned aerial vehicle;
activating electromagnetic magnets to dock and interlock the unmanned aerial vehicle to the platform, and the unmanned aerial vehicle remaining interlocked with the platform during a product delivery process; and
after manually receiving a cargo, deactivating the electromagnetic magnets to release the unmanned aerial vehicle, wherein the unmanned aerial vehicle becomes ready for a flight and takes off from the platform.

2. The system according to claim 1, further comprising:
a motor operating the platform,
a LED lighting employed for an operation of the system under low light conditions,
the electromagnetic magnets used for fixing the unmanned aerial vehicle on the platform,
a transformer box used to supply electrical energy needed by the electromagnetic magnets and the LED lighting,
a control cards box hosting control cards employed to control operations of junction boxes, the motor and the electromagnetic magnets, and
a cable box, wherein connection cables of the system pass through the cable box.

3. The system according to claim 1, wherein a main body of the platform comprises a rear cover, a main carrier bar, a roller bearing carrier, a body left side part, a body right side part, a body bottom part, and a body top part.

4. The system according to claim 1, further comprising a retaining disk and a motor roller bearing carrier, wherein the motor roller bearing carrier ensures a use of the platform after being fixed to a desired place and combines a rear cover, a main carrier bar, a roller bearing carrier, a body left side part, a body right side part, a body bottom part, and a body top part.

5. The system according to claim 1, further comprising a motor roller bearing carrier and a motor.

6. The system according to claim 1, wherein the platform is insulated with waterproof features, is coated by a water- and dirt-repellant nanocomposite coating, and is operable at a temperature range of −20 degrees centigrade to +60 degrees centigrade, wherein a structure of the platform is made of an ultraviolet (UV) resistant material, and the platform further comprises aa insulation band.

7. The system according to claim 2, further comprising a motor roller bearing carrier.

8. The system according to claim 3, further comprising a motor roller bearing carrier and a motor.

9. The system according to claim 4, further comprising a motor.

10. The system according to claim 2, wherein the platform is insulated with waterproof features, is coated by a water- and dirt-repellant nanocomposite coating, and is operable at a temperature range of −20 degrees centigrade to +60 degrees centigrade, wherein a structure of the platform is made of an ultraviolet (UV) resistant material, and the platform further comprises an insulation band.

11. The system according to claim 3, wherein the platform is insulated with waterproof features, is coated by a water- and dirt-repellant nanocomposite coating, and is operable at a temperature range of −20 degrees centigrade to +60 degrees centigrade, wherein a structure of the platform is made of an ultraviolet (UV) resistant material, and the platform further comprises an insulation band.

12. The system according to claim 4, wherein the platform is insulated with waterproof features, is coated by a water- and dirt-repellant nanocomposite coating, and is operable at a temperature range of −20 degrees centigrade to +60 degrees centigrade, wherein a structure of the platform is made of an ultraviolet (UV) resistant material, and the platform further comprises an insulation band.

13. The system according to claim 5, wherein the platform is insulated with waterproof features, is coated by a water- and dirt-repellant nanocomposite coating, and is operable at a temperature range of −20 degrees centigrade to +60 degrees centigrade, wherein a structure of the platform is made of an ultraviolet (UV) resistant material, and the platform further comprises an insulation band.
